(19) United States
(12) Patent Application Publication
(10) Pub. No.: US 2026/0240276 A1
(43) Pub. Date: Aug. 20, 2026

(54) Blind Spot Detection System Using Directional Microphone Array

(71) Applicant: GoPro, Inc., San Mateo, CA (US)

(72) Inventors: Lei Liang, Sydney (AU); Thomas Larcher, Sydney (AU)

(21) Appl. No.: 19/436,582

(22) Filed: Dec. 30, 2025

Related U.S. Application Data
(60) Provisional application No. 63/759,441, filed on Feb. 17, 2025.

(51) Int. Cl. A42B 3/04; B62J 50/21; G08G 1/16

(52) U.S. Cl. CPC A42B 3/046; B62J 50/21; G08G 1/16

(57) ABSTRACT

Blind spot detection based on audio signals is described. A detection method includes training an engine sound detection machine learning model from motorcycle engine sounds collected under a variety of conditions using an array of microphones configured on a helmet during operation of a vehicle, extracting and recognizing in real-time, using the trained engine sound detection machine learning model, an engine sound from other sounds collected by the array of microphones when the helmet is used during operation of the vehicle, separating direct engine sounds from potential reflected signals to estimate distance and direction to potential objects associated with the potential reflected signals, and providing alerts via the helmet upon detection of an object in a blind spot of the vehicle based on the estimated distance and direction to the potential objects.

### CROSS-REFERENCE TO RELATED APPLICATION(S)

This application claims priority to and the benefit of U.S. Provisional Patent Application Ser. No. 63/759,441, filed Feb. 17, 2025, the entire disclosure of which is hereby incorporated by reference.

### TECHNICAL FIELD

This disclosure relates to audio signal based blind spot detection for a helmet.

### BACKGROUND

Motorcyclists often face significant safety risks due to the inadequacy of traditional blind spot monitoring systems that rely on costly radar installations. These radar systems are not only expensive but also complex to integrate, making them impractical for widespread use across different motorcycle models. Moreover, current solutions can be cumbersome and do not adapt well to motorcycles without supporting configurations. There exists a need for an innovative solution that provides effective blind spot monitoring without the high cost, complexity, and model-specific limitations of radar technology.

### SUMMARY

Disclosed herein are implementations of a blind spot detection system for a helmet using audio signals from directional microphones.

In an aspect, a method includes training an engine sound detection machine learning model from motorcycle engine sounds collected under a variety of conditions using microphones configured on a helmet during operation of a vehicle, recognizing in real-time, using the trained engine sound detection machine learning model, one or more engine sounds from sounds collected by the microphones when the helmet is used during operation of the vehicle, separating direct engine sounds from potential reflected signals within the recognized one or more engine sounds to estimate distance and direction to potential objects associated with the potential reflected signals, and providing alerts via the helmet upon detection of one or more of objects of the potential objects in a blind spot of the vehicle based on the estimated distance and direction to the one or more potential objects in the blind spot.

In further aspects, the microphones are an array of microphones deployed around a perimeter of the helmet. In further aspects, the method further includes extracting in real-time, using a feature extraction component, Mel Frequency Cepstral Coefficients from the sounds, wherein the Mel Frequency Cepstral Coefficients are associated with the one or more engine sounds. In further aspects, the trained engine sound detection machine learning model recognizes the one or more engine sounds based on the Mel Frequency Cepstral Coefficients. In further aspects, the method further includes filtering out in real-time, using the trained engine sound detection machine learning model, other sounds from the sounds collected by the microphones when the helmet is used during operation of the vehicle. In further aspects, the method further includes applying frequency domain techniques to the direct engine sounds and the potential reflected signals to estimate time delays for estimating the distance and the direction. In further aspects, the variety of conditions includes different engine operating states and different environmental conditions.

In another aspect, a helmet includes an array of microphones deployed around a perimeter of the helmet, and a processor in communication with the array of microphones. The processor is configured to recognize in real-time, using a trained engine sound detection machine learning model, an engine sound from sounds collected by the array of microphones when the helmet is used during operation of a vehicle, separate a direct engine sound from potential reflected signals within the recognized engine sound to estimate distance and direction to potential objects associated with the potential reflected signals, and provide alerts via the helmet upon detection of an object of the potential objects in a blind spot of the vehicle based on the estimated distance and direction to the potential objects.

In further aspects, the processor is further configured to extract a feature set from the sounds for use with the trained engine sound detection machine learning model to recognize the engine sound. In further aspects, the feature set includes Mel Frequency Cepstral Coefficients associated with the engine sound. In further aspects, the trained engine sound detection machine learning model recognizes the engine sound based on the Mel Frequency Cepstral Coefficients. In further aspects, the processor is further configured to filter out, in real-time, other sounds from the sounds collected by the array of microphones when the helmet is used during operation of the vehicle. In further aspects, the processor is further configured to apply frequency domain techniques to the direct engine sounds and the potential reflected signals to estimate time delays for estimating the distance and the direction.

In yet another aspect, a method includes recognizing in real-time, using a trained engine sound detection machine learning model, an engine sound from sounds collected by array of microphones deployed on a helmet used during operation of a vehicle, separating, by a processor, a direct engine sound from potential reflected signals within the recognized engine sound to estimate distance and direction to potential objects associated with the potential reflected signals, and providing, by the processor, alerts via the helmet upon detection of an object of the potential objects in a blind spot of the vehicle based on the estimated distance and direction to the potential objects.

In further aspects, the method further includes training the engine sound detection machine learning model from motorcycle engine sounds collected under a variety of conditions using the array of microphones configured on the helmet during operation of the vehicle. In further aspects, the method further includes extracting in real-time, using a feature extraction component, Mel Frequency Cepstral Coefficients from the sounds, wherein the Mel Frequency Cepstral Coefficients are associated with the engine sound. In further aspects, the trained engine sound detection machine learning model recognizes the engine sound based on the Mel Frequency Cepstral Coefficients. In further aspects, the method further includes filtering out in real-time, using the trained engine sound detection machine learning model, other sounds from the sounds collected by the array of microphones when the helmet is used during operation of the vehicle. In further aspects, the method further includes applying frequency domain techniques to the direct engine sound and the potential reflected signals to estimate time delays for estimating the distance and the direction. In further aspects, the variety of conditions includes different engine operating states and different environmental conditions.

In yet another aspect, a method for providing alerts in a helmet. The method includes recognizing in real-time, using a trained engine sound detection machine learning model, one or more engine sounds from sounds collected by microphones deployed on the helmet, where the engine sound detection machine learning model is trained from motorcycle engine sounds collected under a variety of conditions using the microphones, separating direct engine sounds from reflected signals within the recognized one or more engine sounds to estimate distance and direction to objects associated with the reflected signals, and providing alerts via the helmet upon detection of one or more of objects in a blind spot of a vehicle based on the estimated distance and direction to the objects in the blind spot.

In further aspects, the microphones are an array of microphones deployed around a perimeter of the helmet. In further aspects, the method includes extracting in real-time, using a feature extraction component, Mel Frequency Cepstral Coefficients from the sounds, wherein the Mel Frequency Cepstral Coefficients are associated with the one or more engine sounds. In further aspects, the trained engine sound detection machine learning model recognizes the one or more engine sounds based on the Mel Frequency Cepstral Coefficients. In further aspects, the method includes filtering out in real-time, using the trained engine sound detection machine learning model, other sounds from the sounds collected by the microphones. In further aspects, the method includes applying frequency domain techniques to the direct engine sounds and the reflected signals to estimate time delays for estimating the distance and the direction. In further aspects, the variety of conditions includes different engine operating states and different environmental conditions.

In yet another aspect, a helmet includes an array of microphones deployed around a perimeter of the helmet, and a processor in communication with the array of microphones. The processor configured to recognize in real-time, using a trained engine sound detection machine learning model, an engine sound from sounds collected by the array of microphones, separate a direct engine sound from reflected signals within the recognized engine sound to estimate distance and direction to objects associated with the reflected signals, and provide alerts via the helmet upon detection of an object in a blind spot of a vehicle based on the estimated distance and direction to the objects.

In further aspects, the processor is further configured to extract a feature set from the sounds for use with the trained engine sound detection machine learning model to recognize the engine sound. In further aspects, the feature set includes Mel Frequency Cepstral Coefficients associated with the engine sound. In further aspects, the trained engine sound detection machine learning model recognizes the engine sound based on the Mel Frequency Cepstral Coefficients. In further aspects, the processor is further configured to filter out, in real-time, other sounds from the sounds collected by the array of microphones. In further aspects, the processor is further configured to apply frequency domain techniques to the direct engine sounds and the reflected signals to estimate time delays for estimating the distance and the direction.

In yet another aspect, a method for providing alerts in a helmet. The method includes recognizing in real-time, using a trained engine sound detection machine learning model, an engine sound from sounds collected by an array of microphones deployed on the helmet, separating, by a processor, a direct engine sound from reflected signals within the recognized engine sound to estimate distance and direction to objects associated with the reflected signals, and providing, by the processor, the alerts upon detection of an object in a blind spot of a vehicle based on the estimated distance and direction to the objects.

In further aspects, the engine sound detection machine learning model is trained from motorcycle engine sounds collected under a variety of conditions using the array of microphones configured on the helmet. In further aspects, the method includes extracting in real-time, using a feature extraction component, Mel Frequency Cepstral Coefficients from the sounds, wherein the Mel Frequency Cepstral Coefficients are associated with the engine sound. In further aspects, the trained engine sound detection machine learning model recognizes the engine sound based on the Mel Frequency Cepstral Coefficients. In further aspects, the method includes filtering out in real-time, using the trained engine sound detection machine learning model, other sounds from the sounds collected by the array of microphones. In further aspects, the method includes applying frequency domain techniques to the direct engine sound and the reflected signals to estimate time delays for estimating the distance and the direction. In further aspects, the variety of conditions includes different engine operating states and different environmental conditions.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is an isometric view of a motorcycle helmet.

FIG. 1B is a schematic view of the motorcycle helmet of FIG. 1A.

FIG. 2 is an exploded view of the motorcycle helmet of FIGS. 1A-1B.

FIG. 3 is a rear schematic view of a face shield of a helmet including an electronic module.

FIG. 4 shows a simplified block diagram of the visual communication system.

FIG. 5 is an isometric view of a motorcycle helmet with an array of microphones.

FIG. 6 is a view of a motorcycle and a helmet with an array of microphones to illustrate range.

FIG. 7 is a view of a motorcycle and a helmet with an array of microphones to illustrate blind spots.

FIG. 8 shows a simplified block diagram of a blind spot detection system.

FIG. 9 is a flowchart of an example technique for training an engine detection machine learning model.

FIG. 10 is a flowchart of an example technique for blind spot detection using audible signals.

FIG. 11 is a flowchart of an example technique for blind spot detection using audible signals.

### DETAILED DESCRIPTION

The implementations disclosed herein enable blind spot detection in helmets and for motorcycles by leveraging an array and/or a network of microphones on the helmet and audio signal processing techniques to enhance rider safety. In the blind spot detection system (BSDS), an array of microphones is strategically placed around the helmet to form a circular array. This configuration can capture direct engine sounds from adjacent vehicles and their acoustic reflections, providing a comprehensive auditory scene of the surrounding traffic. A digital signal processor deployed with audio signal processing techniques and trained machine learning models can process the audio signals captured by the array of microphones. When the BSDS detects a vehicle in the blind spot, the BSDS can trigger visual alerts through a visual alert system integrated in the helmet. These alerts specify the direction from which the detected vehicle is approaching based on the directional information derived from the processed audio signals. In implementations, the visual alert system can have an array of LEDs integrated into the helmet which can be illuminated to indicate the direction of the detected vehicle.

In some implementations, the digital signal processor can employ audio signal processing techniques such as, but not limited to, adaptive filtering, beamforming, and Blind Source Separation (BSS) using Independent Component Analysis (ICA). Adaptive filtering can be utilized to dynamically refine the system's response to environmental noise versus engine sounds from nearby vehicles. Beamforming can enhance the audio signals from specific directions, improving the accuracy of source localization in noisy environments. BSS with ICA can separate independent audio sources from the mixed signals received by the microphone array. This technique effectively isolates and identifies the sound signatures of different vehicles in the rider's vicinity, enabling the system to distinguish between various engine noises and their directional origins accurately.

In some implementations, echo cancellation and noise reduction technology can be integrated to mitigate the interference caused by the motorcycle's own engine noise reflecting off the road and other surfaces. This ensures that the system focuses on external sounds, enhancing detection reliability.

In some implementations, the network of microphones can be, but is not limited to, digital microphones and/or high-precision digital I2S MEMS microphones. In some implementations, the visual alert system can include, but is not limited to, LEDs integrated into the helmet.

In some implementations, the BSDS can use a circular and/or 360° array of high-dynamic-range digital MEMS microphones, each with a dynamic range of higher than 120 dB sound pressure level (SPL), allowing it to capture both loud direct engine sounds and weaker reflected sounds from other vehicles located up to 10 meters away (and in all directions), for example. By employing advanced signal processing techniques and machine learning algorithms, the BSDS can isolate the motorcycle's engine sound and distinguish it from external vehicle sounds, enabling real-time blind spot detection and alert for the rider.

The BSDS not only addresses the limitations of traditional radar-based blind spot detectors by offering a more accessible, cost-effective solution but also enhances the adaptability and usability across different motorcycle models without requiring significant modifications. By using the microphone array only on the helmet, adaptive filtering, and machine learning, the BSDS provides motorcyclists with a robust and adaptable blind spot detection system that is affordable and effective in complex auditory environments. The use of sound processing technology to monitor blind spots introduces a new paradigm in motorcycle safety, providing riders with reliable and intuitive alerts to potential hazards.

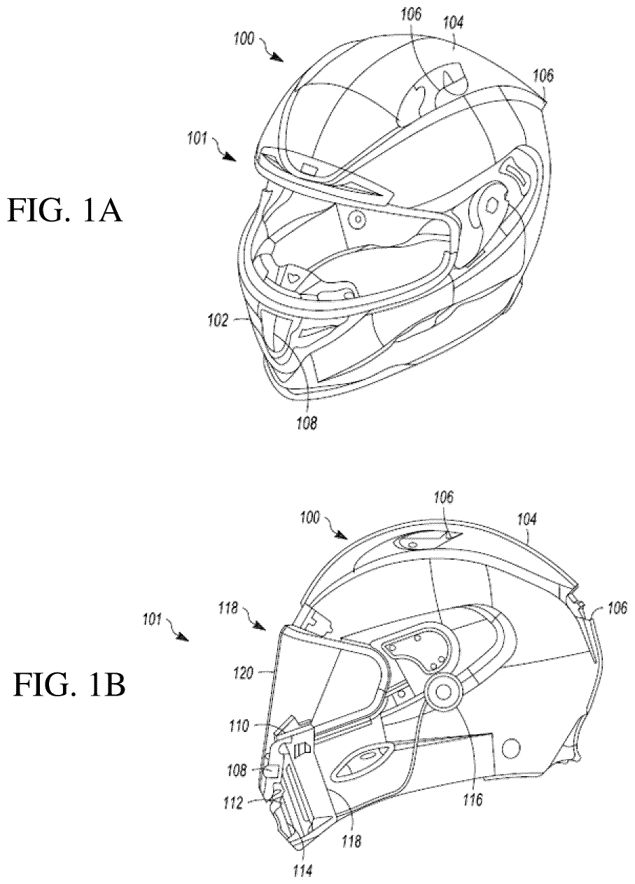

FIG. 1A is an isometric view of a helmet 100 including a visual communication system 101 embedded in the frontal portion of the helmet 102. FIG. 1B is a side schematic view of the helmet 100 and the visual communication system 101 of FIG. 1A.

The helmet 100 has an impact absorbing shell 104, various air vents 106, and a forward mounted camera 108. The impact absorbing shell 104 may be made of composite fiber, carbon fiber, graphite, graphene, or a combination thereof. The air vents 106 allow air to flow into the helmet for cooling such as by air moving into the helmet 100 through the air vents 106 as is experienced during high-speed or downhill motion events. The air vents 106 may be selectively openable depending on the amount of ventilation required. The helmet 100 also comprises an internal lining for comfort purposes.

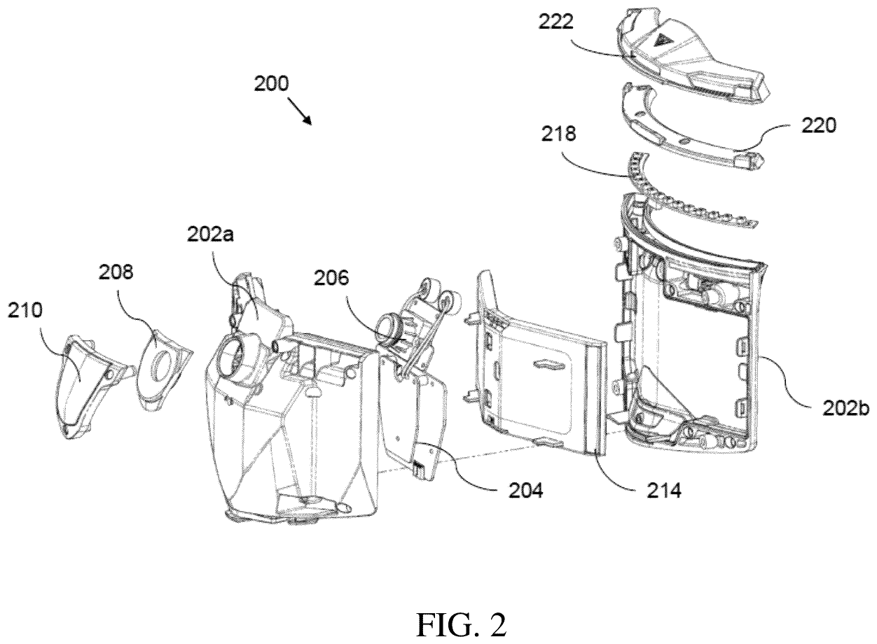

The visual communication system 101 comprises an array or groupings of light emitting devices (light array 110) that emit light in the visible spectrum, that is, light which is visible to the user of the helmet 100. The system also comprises a camera control board 112 and a main electronic board (e.g., the main electronic board 204 shown in FIG. 2) that includes a data communication interface 114. The visual communication system 101 may be connected to integrated speakers and/or drivers 116 that can be used to provide audio aids or riding/driving cues to the user of the helmet 100.

The riding/driving cues are provided to the user in a peripheral field of view so that the user can see the riding/driving cues while focusing a point of view on the road ahead of the user. This allows for a fast reaction to the everchanging riding/driving environment in all riding/driving circumstances. The point of view is a direction in which the user is looking and the field of view is the outside world available to the user of the helmet 100. If the user is directing eyes towards the road, the visual communication system 101 is effective in the user's peripheral vision, that is, the peripheral field of view. Therefore, the user does not have to move gaze or point of view to notice the riding/drive cues in the form of light cues.

On full-face helmets, the viewing region is called the eyeport and/or viewport 118. The eyeport 118 may be covered by a face shield and/or visor 120. The light array 110 or another light source may be positioned so as not to obstruct the eyeport 118. The eyeport 118 may include one or more lenses or displays that a user may see while wearing the helmet 100.

The data communication interface 114 may include a near net communication system such as a Bluetooth module, WIFI module, ZigBee, or a combination thereof arranged to be paired with a mobile communication device. The data communication interface 114 may be arranged to receive situational related data from one or more sources, including from sensors external to the helmet 100. A processing module is configured to analyze the situational related data and using the light array 110, generate light cues or light signals that provide driving or riding guidance to the user of the helmet 100. The visual communication system 101 may also include a memory arranged to store riding/driving and/or navigational data.

Situational data may be related to the vehicle, e.g., a motorcycle, the rider, and/or the surrounding environment. For example, situational related data could be speed of the vehicle, lean angle, weather data, GPS data, or information incoming from a network, such as the internet.

FIG. 2 is an exploded view of a visual communication module 200 similar to the helmet 100 of FIGS. 1A-1B. The visual communication module 200 comprises a housing that houses the main electronic board 204 and the camera module 206. The housing includes of a front panel 202a and a rear panel 202b that can be releasably fastened together. A gasket 208 may be mounted to the front of the housing to prevent water from entering the visual communication module 200 or the helmet (e.g., the helmet 100). The gasket 208 may be made of or include rubber, an elastomer, silicone a flexible material, a semi-rigid material, a rigid material, or a combination thereof. The visual communication module 200 includes the camera module 206 that includes a lens protector 210 that completes an optical path of the camera module 206.

The visual communication module 200 also comprises a battery located in a battery housing 214 and an integrated battery control system. In implementations, the battery and associated components may be located in a rear portion of the shell 104 of the helmet 102. An array of light emitting devices, in this case a multi-color LED array 218, may be positioned along an inner-upper edge of a chin bar of the helmet (e.g., the helmet 100), delivering informational alerts via the projection of light to the user. The LED array 218 supports a full spectrum of color and is paired with a waveguide 220 inside the helmet and a waveguide cover 222 in a manner such that light emitted by the light emitting devices of the LED array 218 is visible to the user.

The data communication interface (e.g., the data communication interface 114) is arranged on the main electronic board 204 which also comprises the processing unit and the memory, the Wi-Fi unit, the Bluetooth module, the LED array control unit, and a gyroscopic unit. The main electronic board 204 is shown adjacent to the camera module 206 but may be positioned elsewhere within the visual communication module 200, such as between the battery housing 214 and the rear panel 202b. The processing unit may include one or more processors having single or multiple processing cores, may be an application specific integrated circuit (ASIC), may be a digital signal processor (DSP), and/or combinations thereof.

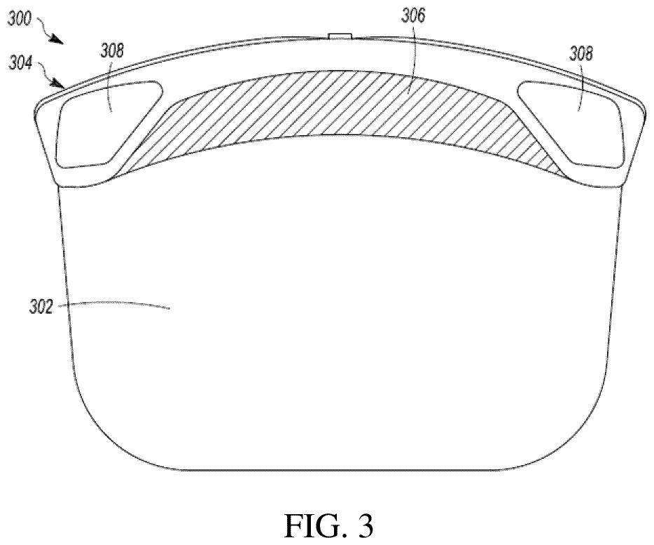

FIG. 3 is a rear schematic view of a face shield 300 that is configured to cover a face of a user of a helmet (e.g., the helmet 100). The face shield 300 includes a shield 302 that protect a user's face and allows the user to see while wearing a helmet. The shield 302 may block debris and other things from contacting the user's face. The face shield 300 includes an electronic module 304.

The electronic module 304 may include one or more screens (or displays) 306. The electronic module 304 may project images, display images, provide information, provide directions, provide feedback, or a combination thereof to the user of the face shield 300. The electronic module 304 may be located across a top of the face shield 300. In other words, the electronic module 304 may be located across an outer extremities of the face shield 300 about a horizontal axis. The electronic module 304 may span from a first end of the face shield 300 to a second end of the face shield 300. The electronic module 304 may extend along a longitudinal axis that extends from the first end to the second end. The electronic module 304 may follow a shape of the face shield 300. The electronic module 304 may extend along a top of the face shield 300, such as above the user's point of view. The electronic module 304 may be located out of a direct field of view of a user, such as in the user's peripheral view. The electronic module 304 may include one or more screens 306 and one or more lenses 308.

The screen 306 shown as part of the face shield 300 extends between a first end and a second end of the face shield 300. The screen 306 may display information to the user as discussed herein. The screen 306 may be flexible. A curvature of the screen 306 may be changed so that images and/or information displayed on the screen 306 may be tuned/focused for or by each individual user. The screen 306 may a liquid crystal display (LCD), an organic light-emitting diode (OLED), or both. The screen 306 may be any type of material so that the screen 306 is flexible and the screen may display the information discussed herein. The screen 306 may not directly display anything. The screen 306 may not be directly visible by a user. The screen 306 may provide light, signals, or both to the lenses 308 and the lenses 308 may display the information to the user. Thus, the screen 306 may be indirectly visible to the user. The screen 306 may be located adjacent to the one or more lenses 308.

The one or more lenses 308, e.g., the lenses 308, may direct light to a location of interest, away from the screen 306, or both. The lenses 308 may direct light, narrow a beam of light, direct light to a predetermined location, or a combination thereof. The lenses 308 may increase light, magnify an image, magnify a symbol, magnify the display, or a combination there of. The lenses 308 may increase a size of an image and/or symbol on a screen by a factor of about 2:1 or more, 3:1 or more, 4:1 or more, 5:1 or more, 6:1 or more, or even 7:1 or more. The lenses 308 may increase a size by about 20:1 or less, 15:1 or less, 12:1 or less, or about 10:1 or less. For example, if the image has a size that is about 1 (e.g., 1 cm) then the image may appear to be about 3 (e.g., 3 cm) if the factor is 3:1. The lenses 308 may be located at the first end and the second end of the face shield 300. The screen 306 may be located between the lenses 308. The screen 306 may be visible only at a location of the lenses 308, between the lenses 308, or at both the lenses 308 and between the lenses 308. The screen 306 may be visible at other locations (e.g., along a center) but may not be focused at the locations other than at the side.

The lenses 308 may be complementary in shape with a portion of the display. The lenses 308 may have a shape that is round, square, rectangular, oval, domed, flat, geometric, nongeometric, or a combination thereof. The lenses 308 may be coplanar to one another in the non-focused state. The lenses 308 may move with the display so 306 as the display is focused so that the displays are no longer coplanar. The lenses 308 may be collimating lenses, may collimate light, or both. The lenses 308 may enlarge an image, direct light towards an eye, clarify an image, or a combination thereof. The lenses 308 may be a Fresnel lens, a diffractive optical lens, a meta surface lens, or a combination thereof. The lenses 308 may direct light from the screen 306, around the screen 306, or both. The lenses 308 may be adjusted so that information on the screen 306 may be focused in a predetermined direction associated with the user. The lenses 308 may be moved to vary an optical length (e.g., a distance between an eye of a user and the lenses 308, the lenses 308 and the screen 306, or both) so that the items to be displayed to the user may be clear and/or in focus for the user. The lenses 308 may physically display the information from the screen 306. The screen 306 may be covered so that information may not be visible by viewing the screen 306, but the screen 306 may be visible through the lenses 308. A single screen 306 may generate images that are displayed through the lenses 308.

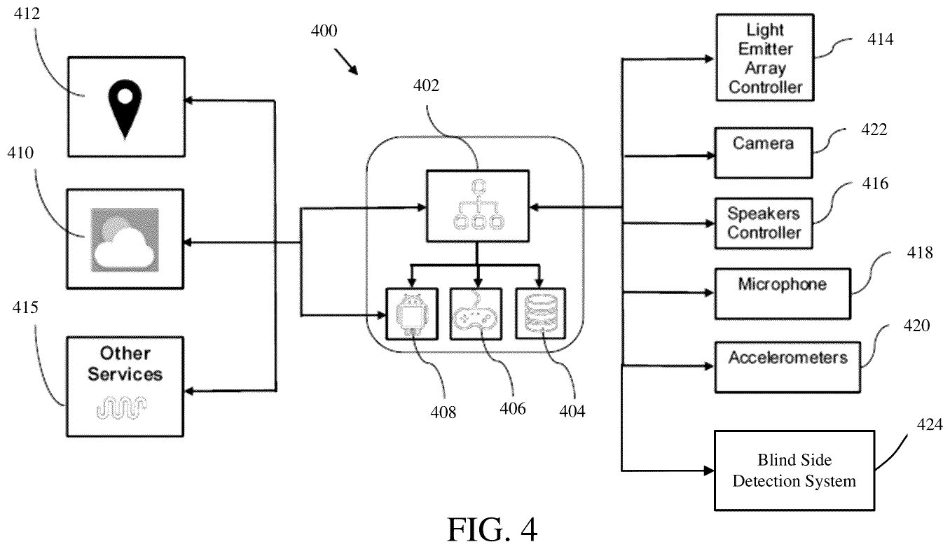

FIG. 4 shows a simplified block diagram of a visual communication system 400 in accordance with embodiments. The system command 402 processes information gathered via sensors and external data streams, coordinates data analysis and information sent to the helmet user via the LED array and, in some instances, the helmet speakers.

The system command 402 can be hosted entirely on a remote web server and communicate with the helmet via a mobile application 408 running on the user's mobile communication device. The system command 402 works in synergy and constant communication with a database 404, an optional controller 406 that can be located on-board the vehicle (for example handlebar of a motorbike) and the mobile application 408.

The database 404 houses all data utilized by the mobile application 408 and provides a storage location for all relevant user-generated data.

The mobile application 408 can be the single point of contact where the helmet can interact with the rich content services provided by the system command 402. The mobile application 408 is responsible for interfacing with the helmet and providing a control point for the peripherals. The mobile application 408 connects directly to the controller located on-board the vehicle.

The system command 402 can retrieve relevant data from a plurality of external data sources, such as weather data 410, navigational and/or traffic data 412, and/or additional data 415, such as local information and alerts. Data streams are sent to the mobile application 408 via the internet connection of the user's mobile communication device. The system command 402 is responsible for the aggregation of third-party data sources, database interaction, and computationally heavy procedures, whilst interacting directly with the mobile application 408.

Local weather forecasting data sources for gathering the weather data 410 are aggregated by the platform for the purpose of delivering location-specific weather information to the user.

Traffic and alerts data sources for obtaining the traffic data 412 are aggregated by the platform for the purpose of delivering location-specific traffic, hazard, and convenience information to the user.

Additional services/data sources for obtaining the additional data 415 are aggregated by the platform for the purpose of delivering pertinent information to the user, relating to areas other than weather and/or traffic and alerts information.

The main electronic board (e.g., the main electronic board 204) connects to the LED array controller 414, the helmet speaker's controller 416, the microphone 418, and one or more accelerometers 420. The helmet connects directly to the mobile application 408, and is worn by the user, enabling them to leverage the on-board peripherals in conjunction with pertinent information delivered via the mobile application.

Motorbike riders have the option of controlling the peripherals and the helmet using a handlebar controller 406. The handlebar controller 406 can interface with the helmet via mobile application 408 or directly via the helmet Bluetooth module. The handlebar controller 406 provides a selection of control functions that are central to the operation of the helmet.

The outward-facing camera 422 allows for recording and playback directly within the mobile application 408 connected to the helmet.

The LED array is controlled through controller 414 that is operated by the system command 402 through the user's mobile communication device and the software application 408. Riding/driving guidance is provided to the helmet user through the LED array and it's based on all the information gathered via the data sources (weather, traffic, others), the on-board system sensors (camera, accelerometers, gyroscope, etc.) and vehicle on-board sensors (6 axes inertial system, braking force, G-force, velocity sensors, engine temperature, oil level, gas level, brake health, suspension setting).

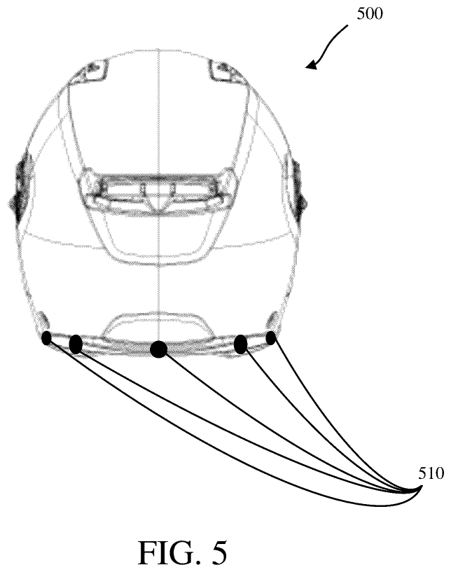

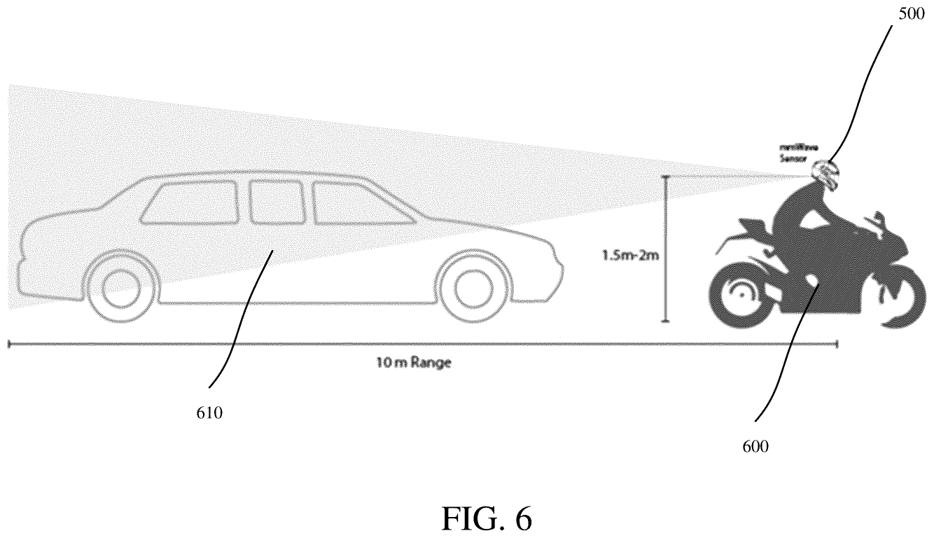

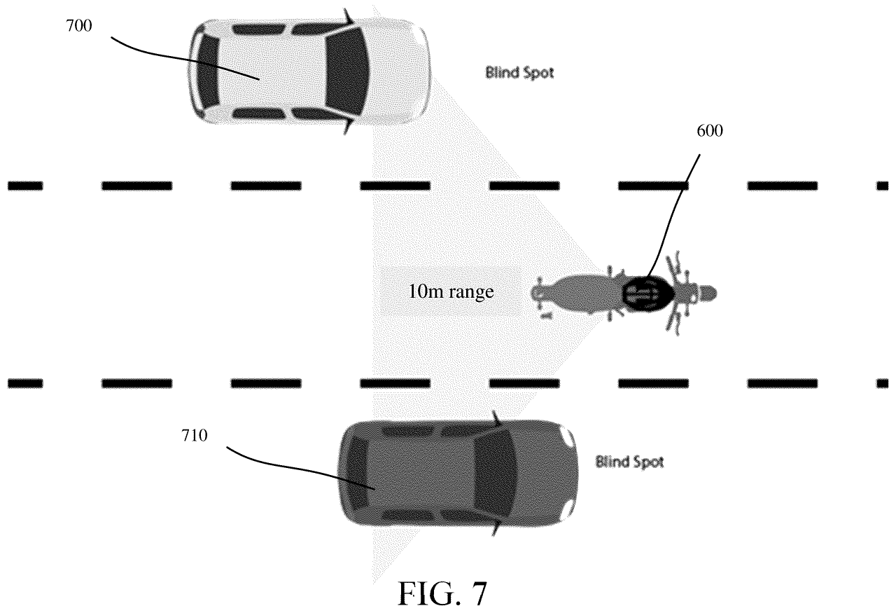

Reference is now also made to FIG. 5, which is an isometric view of a helmet 500 with an array of microphones 510. The microphone 418 can be the array of microphones 510. The array of microphones 510 can high-dynamic-range MEMS microphones with a 120 dB SPL range, capable of distinguishing between loud direct engine sounds and faint reflected sounds for a defined range. The array of microphones 510 can be deployed as a 360-degree microphone array. The array of microphones 510 can be strategically placed around the helmet 500 to capture sounds from all directions. The array of microphones 510 can capture environmental sound signals, the motorcycle's own engine noise, and any reflected sounds from surrounding objects. FIG. 6 is a view of a motorcycle 600 and the helmet 500 with the array of microphones 510 to illustrate the defined range to a vehicle 610, for example. In implementations, the defined range is up to 10 meters away. FIG. 7 is a view of the motorcycle 600 to illustrate the defined range to a vehicle 700 and a vehicle 710, which are in blind spots with respect to the motorcycle 600.

Referring back to FIG. 4, a blind side detection processing system 424 is connected to or in communication with the microphone 418, the controller 414, and/or other components of the visual communication system 400 to provide blind spot detection using audio signals from the microphone 418 and/or the array of microphones 510. Upon detection of a vehicle in a blind spot, the blind side detection processing system 424 can cause the controller 414 and the LEDs on the helmet 500 to alert a rider of the motorcycle. The blind side detection processing system 424 can be on, connected to, and/or in communication with the main electronic board 204.

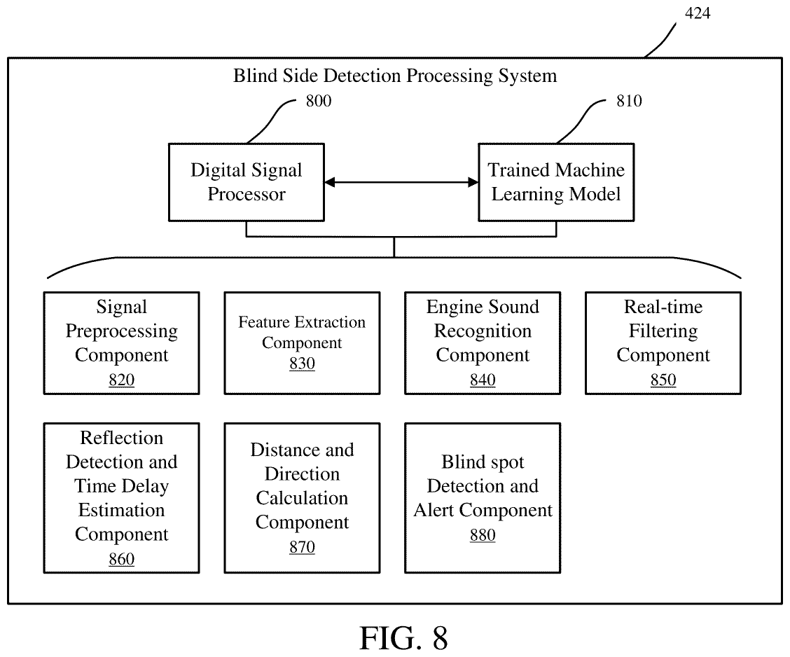

Reference is now also made to FIG. 8, which is a simplified block diagram of the blind spot detection processing system 424. The blind spot detection processing system 424 can include, but is not limited to, a digital signal processor (DSP) (DSP 800) and a trained machine learning model 810. The DSP 800 can execute adaptive filtering techniques to isolate the motorcycle's engine sound in real-time. The adaptive filtering techniques can filter out ambient noise and other vehicles' engine sounds, ensuring precise detection. The DSP 800 can extract Mel Frequency Cepstral Coefficients (MFCC), representing the unique spectral characteristics of the engine sound. The trained machine learning model 810 can recognize the engine's specific voiceprint, creating a custom filter. That is, the trained machine learning model 810 can identify and classify the motorcycle's unique engine sound characteristics, allowing accurate distinction between direct engine sounds and reflected sounds.

The blind side detection processing system 424 can include, but is not limited to, a signal preprocessing module, component, unit, and/or engine (“signal preprocessing component 820”), a feature extraction component 830, an engine sound recognition component 840, a real-time filtering component 850, a reflection detection and time delay estimation component 860, a distance and direction calculation component 870, and a blind spot detection and alert component 880, all of which are executed by the DSP 800 to process and interpret the sound data to provide real-time alerts to the rider.

The signal preprocessing component 820 can process the sounds collected via the microphone 418 and/or the array of microphones 510. The signal preprocessing component 820 can perform operations, including but not limited to, filtering to remove unwanted frequencies, noise reduction to eliminate background noise, framing to segment the continuous audio signal into manageable frames, and windowing to prepare the signal for feature extraction. This processing can enhance the quality of the audio signal for accurate analysis in subsequent stages and/or components as described herein.

The feature extraction component 830 can extract specific features from the preprocessed sound signals to characterize the audio data effectively. The primary feature extracted is the Mel Frequency Cepstral Coefficients (MFCC), which captures the spectral properties of the sound. Other acoustic features are also extracted to improve the robustness of the system 424.

The engine sound recognition component 840 can process the feature vectors. The engine sound recognition component 840 can utilize the trained machine learning model 810 to recognize the motorcycle's own engine sound from the extracted features (which can include the MFCC). During an initial training phase as described herein, the system 424 can train a machine learning model to learn the unique sound signature of the motorcycle's engine. The output is a specialized filter or trained model (e.g., the trained machine learning model 810) that distinguishes the engine sound from other environmental sounds.

The trained machine learning model 810 can be applied in the real-time filtering component 850 to process incoming sound signals continuously. The real-time filtering component 850 can filter out extraneous sounds such as other vehicles' engine noises and ambient environmental noise, retaining only the motorcycle's own engine sound and any reflected signals. This selective filtering can isolate the relevant signals needed for accurate blind spot detection.

The reflection detection and time delay estimation component 860 can analyse the filtered sound signals to detect reflections of the motorcycle's engine sound from surrounding objects (i.e., reflection detections). By identifying these reflected signals, the system 424 can estimate the time delay between the emission of the engine sound and the reception of its reflection. This time delay indicates the distance to the reflecting object.

The distance and direction calculation component 870 can calculate the distance and direction of the reflecting objects relative to the motorcycle by utilizing the estimated time delays and the spatial information from the circular microphone array. To address the challenges posed by the periodic nature of the engine sound, the system 424 can employ a frequency domain phase difference estimation method. By analyzing the phase differences between the frequency spectra of the direct engine sound and its reflections, the system 424 can accurately estimate the time delays without ambiguity. The frequency domain phase difference estimation method can overcome the limitations of traditional time-domain approaches, allowing precise calculation of the distance and direction of reflecting objects, thereby enhancing the reliability of blind spot detection.

The blind spot detection and alert component 880 and/or system 424 can assess whether any detected objects are within the motorcycle's blind spots. If an object is determined to be in a blind spot and poses a potential hazard, the blind spot detection and alert component 880 can trigger an alert to the rider. The alert can be delivered through auditory signals, visual indicators on a helmet-mounted display, haptic feedback, and/or combinations thereof, enhancing the rider's situational awareness and safety.

In implementations, blind spots in the system may be defined based on the motorcycle's forward direction and spatial geometry. To ensure consistency, the angles are defined relative to the motorcycle's forward motion. In a non-limiting implementation, an angle coordinate system for the motorcycle may be defined as follows:
0° (forward direction): the direction in which the motorcycle is moving.
+90° (right side): the perpendicular direction to the motorcycle's right.
−90° (left side): the perpendicular direction to the motorcycle's left.
+/−180° (rear direction): directly behind the motorcycle, both positive and negative 180° represent the same point due to symmetry.

In a non-limiting implementation, the blind spot angular ranges may be defined as follows:
Left Blind Spot: 135°≤θ≤180° (rear-left region).
Right Blind Spot: −180°≤θ≤−135° (rear-right region).

In a non-limiting implementation, a blind spot distance range or blind spot detection distance range may be a defined distance from the motorcycle. In implementations, the defined distance may be about 1 meter to about 8 meters.

As a rider's head (and helmet) may rotate during the riding, the system may dynamically adjust to align the computed direction with the motorcycle's global coordinate system. The helmet's IMU may measures the angular offset φ of the helmet relative to the motorcycle's forward direction. The computed angle θₕₑₗₘₑₜ from the microphone array (in the helmet's local coordinate system) is corrected as:

$${θ}_{global} = {θ}_{helmet} - ϕ$$

where θ_{global} is the corrected angle relative to the motorcycle's forward direction.

Blind spot validation may be defined as follows:
Left Blind Spot: 135°≤θ_{global}≤180°
Right Blind Spot: −180°≤θ_{global}≤−135°

As noted above, the BSDS uses machine learning techniques for engine sound recognition. Accordingly, the BSDS has a training phase and a real-time detection phase. During the training phase, a rider wears the helmet and activates a training mode. The BSDS can collect sound data specific to the motorcycle's engine under various operating conditions. The collected data is processed through the signal preprocessing and feature extraction components. The engine sound recognition component can then train a machine learning model using this data to create a specialized filter that accurately recognizes the motorcycle's engine sound.

Once trained, the BSDS can switch to a real-time detection mode for normal operation. The helmet-mounted microphones can continuously collect environmental sound signals, which are processed through the components as described. The real-time filtering module can apply the specialized filter to isolate the engine sound and its reflections. The subsequent components can analyse these signals to detect objects in the blind spots and provide timely alerts to the rider.

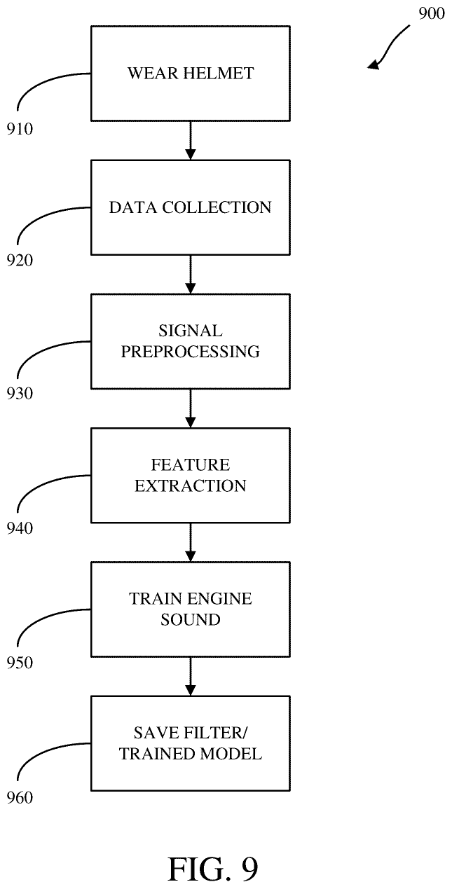

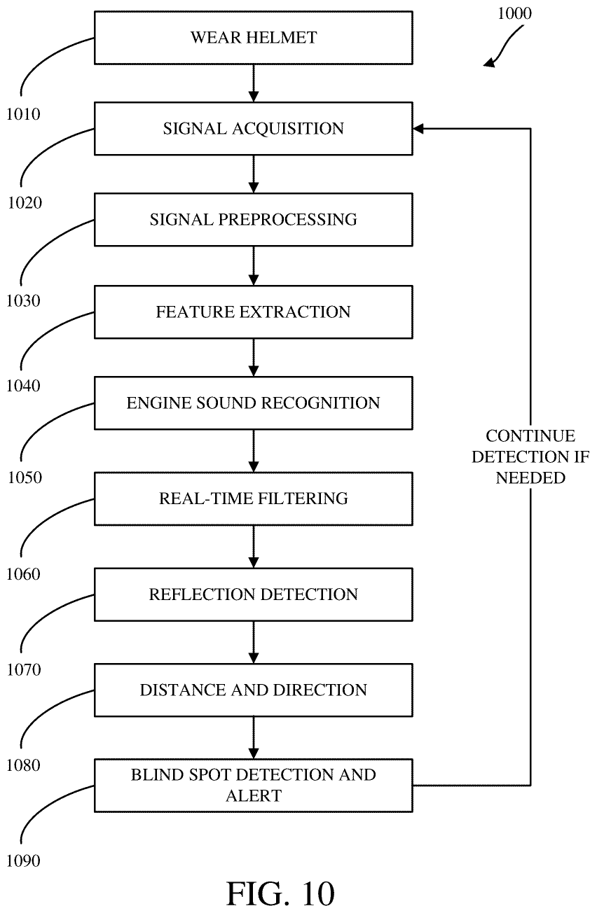

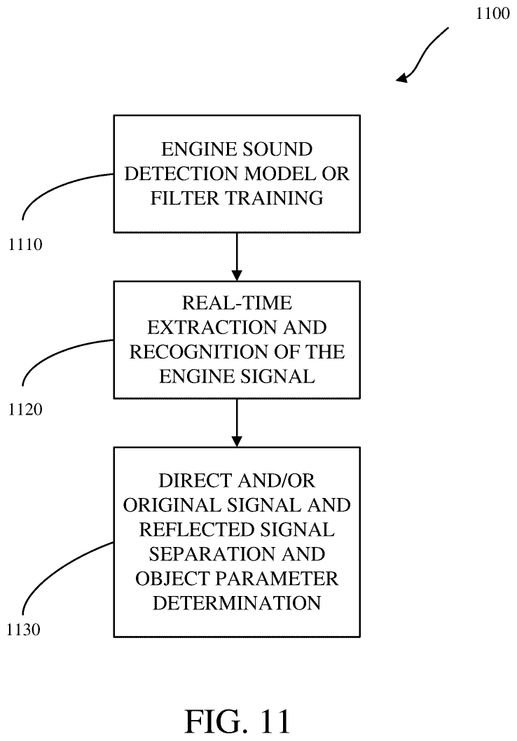

FIG. 9 is a flowchart of an example technique 900 for training an engine detection machine learning model. For example, the technique 900 may be implemented by the helmet 100 shown in FIGS. 1A-1B, 2, and 3, the visual communication system 400 shown in FIG. 4, the helmet 500 shown in FIGS. 5 and 6, the processing system 424 shown in FIG. 8, and in conjunction with the techniques shown in FIGS. 10 and 11, as appropriate and applicable.

At 910, a rider of a motorcycle places a helmet (with the microphone array) on with a correct posture and position so as to accurately capture the sound environment as experienced during actual riding conditions. When reading data, the direction of the helmet must not change. During movement, the actual direction of the helmet will be corrected using data obtained from GPS and IMU systems.

At 920, a data collection component can collect engine sound and ambient noise. For example, the data collection component can include, but is not limited to, the microphone array and memory/storage. The microphone array is activated to start recording. Sounds should be recorded for all and/or different engine operating states including, but not limited to, idle, acceleration, deceleration, and/or cruising at different speeds. Sounds should be recorded for all and/or different environmental conditions including, but not limited to, traffic environments, weather conditions, and/or road types. Sounds should be recorded for all and/or different engine operating states, all and/or different environmental conditions, and/or combinations thereof (collectively “recording conditions”). The recording duration should be sufficient to capture the variability in engine sounds and ambient noises in all recording conditions. In implementations, the recording duration can be approximately 5 minutes for each condition. In implementations, the recorded audio data can be stored in a raw format (WAV files) with high sampling rates (48 kHz) to preserve sound quality.

At 930, a signal preprocessing component can perform signal preprocessing on the collected audio data. The signal preprocessing can include, but is not limited to, filtering, noise reduction, framing, and windowing. The signal preprocessing can enhance the quality of the recorded audio data and/or signals and prepare the audio data and/or signals for feature extraction.

The filtering can use bandpass filtering to retain frequencies where the engine sound is prominent while eliminating irrelevant frequency components. A digital band-pass filter (i.e., a Butterworth filter) can be applied to the recorded audio data and/or signals with cutoff frequencies selected based on the engine's frequency characteristics (e.g., 50 Hz to 1 kHz).

The noise reduction can reduce ambient noise and improve the signal-to-noise ratio of the recorded audio data and/or signals. A variety of techniques can be used, including but not limited to, spectral subtraction and/or adaptive filtering. Spectral subtraction can estimate the noise spectrum during silent periods and subtract it from the signal spectrum. Adaptive filtering can use Least Mean Squares (LMS) algorithms to adaptively filter out noise.

Framing can be used to segment the continuous audio signal into short frames suitable for analysis, capturing the quasi-stationary nature of speech-like signals. In implementations, the frame length can be 25 milliseconds. In implementations, frames can be overlapped or shifted with a shift of 10 milliseconds to ensure smooth transitions.

A window function can be applied to each frame to reduce spectral leakage. In implementations, a Hamming window can be used. Equation (1) is an illustrative windowing equation:

$$\text{?} - 0.46 cos ( \frac{2 π n}{N - 1} ) , 0 \leq n \leq N - 1 \qquad Equation ( 1 )$$

$$\text{?} \text{indicates text missing or illegible when filed}$$

where each frame x(n) can be multiplied by the window function w(n) as shown in Equation (2):

$${x}_{w} ( n ) = x ( n ) \cdot w ( n ) \qquad Equation ( 2 )$$

At 940, feature extraction can be applied to extract MFCC and other features. A feature extraction component can convert the time-domain signal into a set of features that effectively represent the engine sound characteristics. The feature extraction component can execute a feature extraction process to extract the MFCC and other features.

The feature extraction process can include application of a Fast Fourier Transform (FFT). Each windowed frame can be transformed from the time domain to the frequency domain. A FFT for each frame x_{w}(n) can be computed using Equation (3):

$$\text{?} ( n ) {e}^{- j 2 π kn / N} , 0 \leq k \leq N - 1 \qquad Equation ( 3 )$$

$$\text{?} \text{indicates text missing or illegible when filed}$$

The feature extraction process can compute a power spectrum and/or magnitude spectrum of the signal using Equation (4):

$$P ( k ) = {\vert X ( k ) \vert}^{2} \qquad Equation ( 4 )$$

The feature extraction process can apply Mel filter bank processing to the signal. The feature extraction process can map power spectrum onto the Mel scale to mimic the human ear's perception of sound using Equation (5):

$${f}_{mel} = 2595 {log}_{10} ( 1 + \frac{f}{700} ) \qquad Equation ( 5 )$$

The feature extraction process can apply set of triangular filters spaced uniformly on the Mel scale (e.g., 26 filters) and determine a filtered energy using Equation (6):

$${S}_{m} = {\sum }_{k = {k}_{m} - 1} P ( k ) {H}_{m} ( k ) , m = 1 , 2 , … , M \qquad Equation ( 6 )$$

where Hₘ(k) is the m-th Mel filter.

The feature extraction process can perform a logarithm on the filtered energies to convert to a logarithmic scale to emulate the human ear's sensitivity using Equation (7):

$$log {S}_{m} = log ( {S}_{m} ) \qquad Equation ( 7 )$$

The feature extraction process can perform a Discrete Cosine Transform (DCT) to decorrelate the filter bank coefficients to obtain the Mel Frequency Cepstral Coefficients (MFCCs) using Equation (8):

$${c}_{n} = {\sum }_{m = 1} log {S}_{m} cos [ \frac{π n ( m - 0.5 )}{M} ] , n = 1 , 2 , … , L \qquad Equation ( 8 )$$

where L is the number of desired coefficients (e.g., 12 or 13).

The feature extraction process can perform feature vector construction to determine additional features, such as Delta and Delta-Delta coefficients to represent the temporal dynamics, using Equations (9) and (10), for example:

$$\text{?} - {c}_{n}^{( t - 1 )} \qquad Equation ( 10 )$$

$$ΔΔ {c}_{n} = Δ {c}_{n}^{( t + 1 )} - Δ {c}_{n}^{( t - 1 )}$$

$$\text{?} \text{indicates text missing or illegible when filed}$$

The feature extraction process can determine a final feature vector by concatenation of the MFCCs, the delta feature, and the delta-delta feature, for example, to form the feature vector f as shown in Equation (11):

$$\text{?} , Δ {c}_{1} , Δ {c}_{2} , … , Δ {c}_{L} , {Δ}^{2} {c}_{1} , {Δ}^{2} {c}_{2} , … , {Δ}^{2} {c}_{L} ] \qquad Equation ( 11 )$$

$$\text{?} \text{indicates text missing or illegible when filed}$$

The feature extraction process can prepare datasets for machine learning training, validation, and test sets. Preparation of the datasets includes labeling the feature vectors as positive samples or negative samples. Positive samples are feature vectors which correspond to frames containing the motorcycle's engine sound. Negative samples are feature vectors corresponding to frames containing ambient noise and other sounds. The dataset, with labels, can be split into training, validation, and test sets. In implementations, a defined percentage in each set can be 70% to the training set, 15% to the validation set, and 15% to the test set.

At 950, a convolutional neural network (CNN) model can be trained to generate or form an engine sound recognition model. The engine sound recognition model can accurately recognize the motorcycle's engine sound based on the extracted features.

The CNN model can include, but is not limited to, an input layer, convolutional layers, pooling layers, fully connected layers, and output layers. The input layer can accept reshaped feature vectors suitable for CNN input. The convolutional layers can extract local patterns and features from the input data. The pooling layers can reduce dimensionality and focus on dominant features. The fully connected layers can integrate extracted features for classification. The output layer can produce the final classification output indicating the presence of the engine sound.

The training and valid sets can be used for the training process. Optimizers and loss functions (e.g., binary cross-entropy) are selected for the CNN model. The loss function is the quantity that will be minimized during training. The optimizer determines how the network will be updated based on the loss function. The CNN model can be trained over multiple epochs with a mini-batch gradient descent. The performance of the CNN model can be assessed using metrics like accuracy, precision, recall, and F1 score. The CNN model can be validated to ensure generalization to unseen data.

At 960, the trained CNN model is converted and saved as the engine sound recognition model or filter model on the DSP, such as the DSP 800. That is, the trained CNN model can be prepared for deployment on the DSP within the helmet. The preparation can include conversion of the trained CNN model into a format compatible with the DSP hardware. The preparation can include translation of the trained CNN mode into fixed-point arithmetic supported by the DSP. The converted and translated trained CNN model can be stored in the DSP's memory or associated storage. The functionality of the converted model can be verified through testing on the DSP hardware.

The system now possesses a trained CNN model capable of accurately recognizing the motorcycle's engine sound based on MFCC features. It is ready to proceed to the real-time detection phase.

FIG. 10 is a flowchart of an example technique 1000 for blind spot detection using audible signals. The technique 1000 can use the trained CNN model as described using the technique 900. For example, the technique 1000 may be implemented by the helmet 100 shown in FIGS. 1A-1B, 2, and 3, the visual communication system 400 shown in FIG. 4, the helmet 500 shown in FIGS. 5 and 6, the processing system 424 shown in FIG. 8, and in conjunction with the techniques shown in FIGS. 9 and 11, as appropriate and applicable.

At 1010, a rider of a motorcycle places a helmet as noted for step 910 in FIG. 9.

At 1020, audio data and/or signals can be acquired and/or collected as the motorcycle is driven using the microphone array. In implementations, the audio data can be stored in a raw format (WAV files) with high sampling rates (48 kHz) to preserve sound quality.

At 1030, a signal preprocessing component can perform signal preprocessing on the collected audio data as discussed in step 930.

At 1040, feature extraction can be applied to extract MFCC and other features as described in step 940

At 1050, the engine sound recognition model can be used to recognize the engine sounds. That is, the extracted features are input into the deployed CNN model on the DSP to recognize and extract the engine sound.

At 1060, real-time filtering can be done using the engine sound recognition model. The filtering can filter out extraneous sounds such as other vehicles' engine noises and ambient environmental noise, retaining only the motorcycle's own engine sound and any reflected signals. This selective filtering is crucial for isolating the relevant signals needed for accurate blind spot detection.

At 1070, the motorcycle's own engine sound and any reflected signals are processed to determine whether there are any objects that are reflecting the engine sounds.

The motorcycle's engine produces a periodic “/tutututu/” sound, resulting in a waveform with repetitive peaks. In the time domain, cross-correlation functions of such periodic signals exhibit multiple peaks corresponding to different cycles of the signal. This multiplicity leads to ambiguity in peak selection, making it difficult to accurately determine the time delay of the reflected signal. If the wrong peak is aligned during time delay estimation, the calculated time delay deviates from the actual value. This deviation introduces significant errors in distance estimation, adversely affecting the reliability of the BSDS.

The BSDS can use frequency domain techniques to address the periodic nature of the engine sound and the ambiguity resulting therefrom. By analysing the phase differences between the frequency spectra of the direct engine sound and its reflections, the BSDS can accurately estimate time delays without ambiguity. The direct engine sound x(t) and the reflected signals y(t) need to be determined.

The discussion herein uses a number of the terms. The term yᵢ(t) is the total signal received by the i^{th} microphone. As such, the term yᵢ(t) comprises direct sound (x(t−τᵢ)), reflected sound (y_{reflected,i}(t)), and noise. The term x(t−τᵢ) is the direct sound signal from the motorcycle engine, delayed by τᵢ to account for the travel time to the i^{th} microphone. The term x(t−τᵢ) serves as the baseline for extracting the reflected signal. The term y_{reflected,i}(t) is the reflected signal extracted from yᵢ(t) representing the sound reflected from surrounding objects and is defined in Equation (12).

Extraction of an estimated direct engine sound x(t) as it would be received without reflections can be done using the engine sound recognition model or beamforming techniques. The engine sound recognition model can used to reconstruct the direct engine sound. The MFCCs extracted during feature extraction can be used as inputs to the engine sound recognition model to generate an estimated direct engine sound signal. The beamforming techniques can enhance the direct sound coming from the engine's known location (beneath the rider) and suppress sounds from other directions. The beamforming techniques can include, but are not limited to, a delay-and-sum beamforming technique and an adaptive beamforming technique. The delay-and-sum beamforming technique can delay the signals from each microphone to align the direct sound components based on the known geometry. The delay-and-sum beamforming technique can then sum the aligned signals to enhance the direct sound and attenuate reflections. The adaptive beamforming technique can use algorithms like Minimum Variance Distortionless Response (MVDR) to adaptively enhance the direct sound.

The reflected signals y(t) can be obtained or isolated by removing the estimated direct engine sound from the received signals using a variety of techniques, including but not limited to, a subtraction method and an adaptive filtering method.

For the subtraction method, estimate a direct sound component for each microphone signal y(t). This can be done by using the estimated direct engine sound x(t) and accounting for the time delay between the engine and each microphone i. An expected time delay τᵢ (or τᵢ) from the engine to microphone i is calculated based on the geometry. The estimated direct engine sound x(t) is delayed by Ti to align with the direct sound component in yᵢ(t). The reflected signal can then be determined using Equation (12):

$$\text{?} ( t ) = {y}_{i} ( t ) - x ( t - {τ}_{i} ) \qquad Equation ( 12 )$$

$$\text{?} \text{indicates text missing or illegible when filed}$$

where the residual y_{reflected}_{ᵢ}(t) contains primarily the reflected components.

For the adaptive filtering method, adaptive filters (Least Mean Squares (LMS) algorithm) can be used to model and subtract the direct sound from the received signals. In this instance, the estimated direct engine sound x(t) can be used as a reference signal. Filter coefficients can be adjusted to minimize the error between the estimated direct sound x(t) and the actual received signal. The error signal or residual signal (difference between the received signal and the filtered direct sound) represents the reflections.

Now that x(t) and y(t) (the reflected signals y_{reflected}(t)) are separated, proceed with the frequency domain phase difference estimation as previously described. That is, overlapping, windowing, FFT, and power spectrum processing can be performed to determine frequency domain phase difference estimation.

Short-Time Fourier Transform (STFT) computation can be done for the x(t) and y(t) signals, where windowing and overlap settings are used with are suitable for frequency resolution.

Phase difference calculations are determined using Equations (13, (14), and (15), respectively:

$$\text{?} ( f , n ) = arg [ X ( f , n ) ] {ϕ}_{x} ( f , n ) = arg [ X ( f , n ) ] \qquad Equation ( 13 )$$

$$\text{?} ( f , n ) = arg [ Y ( f , n ) ] {ϕ}_{y} ( f , n ) = arg [ Y ( f , n ) ] \qquad Equation ( 14 )$$

$$Δ ϕ ( f , n ) = {ϕ}_{y} ( f , n ) - {ϕ}_{x} ( f , n ) \qquad Equation ( 15 )$$

$$\text{?} \text{indicates text missing or illegible when filed}$$

In implementations, phase unwrapping and multi-frequency fusion may be used to estimate the time delay Δt. Both phase unwrapping and multi-frequency fusion may improve the precision of the time delay estimation. These techniques represent an enhancement node in the system pipeline to achieve higher accuracy in specific scenarios.

In implementations, phase unwrapping may be used to address the phase ambiguity problem. When the phase of a signal is expressed in radians, it is typically restricted to the range [−π,π]. Due to this limitation, the actual phase may “jump” by multiple 2π cycles, leading to discontinuities. Phase unwrapping detects and corrects these jumps, restoring the continuous, true phase values. In time delay estimation, phase values are computed across multiple frequency components. If raw, unwrapped phase values are directly used, the 2x periodic ambiguity may cause errors in delay calculations. Phase unwrapping ensures that adjacent frequencies or time points have consistent phase values, eliminating ambiguity and improving the accuracy of time delay estimation.

In implementations, multi-frequency fusion may be used to combine phase information from multiple frequency components to enhance the robustness and precision of time delay estimation. Single-frequency phase estimates may be affected by noise, leading to instability. Multi-frequency fusion aggregates information across frequencies using weighted averaging or optimization techniques, reducing noise sensitivity. In signal processing, the reflected signal from a target often spans multiple frequency bands. By estimating the time delay across these bands and fusing the results, the overall delay estimate becomes more accurate and robust. Multi-frequency fusion also helps mitigate noise effects that may affect individual frequency components.

At 1080, the estimated time delay can be converted into a distance to the reflecting object. This can be done by using the speed of sound v (approximately 343 meters per second at room temperature) as shown in Equation (16):

$$D = \frac{v \cdot Δ t}{2} \qquad Equation ( 16 )$$

The direction of arrival (DOA) of the reflected sound can be estimated using the microphone array. That is, the spatial configuration of the microphone array can be used to estimate the incident angle of the reflected sound.

For each pair of microphones i and j, a phase difference can be computed using Equation (17):

$$\text{?} ( f , n ) = {ϕ}_{yi} ( f , n ) - {ϕ}_{yj} ( f , n ) \qquad Equation ( 17 )$$

$$\text{?} \text{indicates text missing or illegible when filed}$$

Phase unwrapping can be applied to the phase difference.

A time difference between microphones i and j can be computed (time difference of arrival (TDOA)) using Equation (18):

$$\text{?} = \frac{{Δϕ}_{ij} ( f , n )}{2 π f} \qquad Equation ( 18 )$$

$$\text{?} \text{indicates text missing or illegible when filed}$$

The direction can be calculated using geometry-based estimation. The known positions of the microphones and the calculated TDOAs can be used to estimate the incident angle θ. For a linear array this is:

$$\text{?} ( \frac{v \cdot Δ {t}_{ij}}{{d}_{ij}} ) \qquad Equation ( 19 )$$

$$\text{?} \text{indicates text missing or illegible when filed}$$

where dᵢⱼ is the distance between microphones i and j. At this point, the distance D and angle θ data of the object and/or a blind spot vehicle have been obtained.

At 1090, the distance D and angle θ data can be used to determine whether a blind spot detection alert is provided to the rider via audible or light systems on the helmet and/or motorcycle/vehicle.

The process can be continued as long as the helmet is active and/or the vehicle is moving.

FIG. 11 is a flowchart of an example technique 1100 for blind spot detection using audible signals. The technique 1100 can use the trained CNN model as described using the technique 900 and the technique 1000. For example, the technique 1100 may be implemented by the helmet 100 shown in FIGS. 1A-1B, 2, and 3, the visual communication system 400 shown in FIG. 4, the helmet 500 shown in FIGS. 5 and 6, the processing system 424 shown in FIG. 8, and in conjunction with the techniques shown in FIGS. 9 and 10, as appropriate and applicable.

At 1110, an engine sound detection model or filter is trained. The filter is capable of recognizing and extracting the motorcycle's own engine sound, distinguishing it from ambient noise and sounds from other vehicles. Training of the engine sound detection model includes, but is not limited to, data collection, signal preprocessing, feature extraction, model training, and model deployment. Data collection can gather engine sound and environmental noise data under various operating conditions. Signal preprocessing can apply filtering, noise reduction, framing, and windowing to the collected data. Feature extraction can extract MFCCs and their first and second derivatives (delta and delta-delta coefficients). Model training can use a CNN trained on the extracted features to generate a model that accurately recognizes the engine sound. The trained model is converted into a format suitable for a DSP within the helmet and store it for real-time use.

At 1120, real-time extraction and recognition of the engine signal is done. This filters out other environmental sounds. Extraction and recognition can include, but is not limited to, signal acquisition, signal preprocessing, engine sound recognition, and real-time filtering. Signal acquisition can continuously collect ambient sound using the helmet-mounted microphone array. Signal preprocessing can perform filtering, noise reduction, framing, and windowing on the real-time audio signals. During engine sound recognition, the extracted features are input to the deployed CNN model on the DSP to recognize and extract the engine sound. The engine sound recognition results can be used to filter out other sounds, retaining only the engine sound signal.

At 1130, direct and/or original signal and reflected signal separation can be done to enable estimation of distance and angle of potential objects (object parameter determination). That is, direct engine sound is separated from its reflections off surrounding objects, enabling accurate estimation of the distance and direction to potential obstacles. This separation processing can include, but is not limited to, signal separation, frequency domain phase difference estimation, and distance and direction calculation.

The signal separation includes direct sound estimation and reflected sound extraction. The direct sound estimation is used to enhance the direct engine sound using array signal processing techniques like beamforming. The reflected sound extraction can subtract the estimated direct sound from the received signals to isolate the reflected sound components.

The frequency domain phase difference estimation can apply STFT to both the direct and reflected signals to obtain their frequency spectra, compute the phase differences between the direct and reflected signals at various frequencies, unwrap the phase differences to ensure continuity over time, and calculate time delays based on the unwrapped phase differences and corresponding frequencies.

The distance and direction calculation can use the time delays and the speed of sound to calculate distances to reflecting objects and determine the directions of the reflected sounds using spatial information from the microphone array.

The system can accurately detect objects within the motorcycle's blind spots in real time and provide timely alerts to the rider, thereby enhancing riding safety.

Described is a visual alert system for motorcycle helmets with directional microphone arrays and DSP for emergency vehicle detection.

Motorcycle riding environments are typically noisy, predominantly due to engine sounds, which can pose a hearing risk and reduce comfort. While motorcycle helmets provide excellent physical noise insulation, they can inadvertently block critical external sounds such as sirens from emergency vehicles like police cars, ambulances, and fire trucks. Existing solutions may not effectively balance noise insulation with the need to remain alert to important external cues, which is crucial for rider safety.

An advanced auditory alert system for motorcycle helmets is described that enhances the detection and awareness of emergency vehicle sirens. The system incorporates an array of microphones positioned around the helmet's perimeter to form a circular array, working in conjunction with the DSP. The DSP is deployed with a trained machine learning model and/or equipped with a specialized neural network to identify various emergency vehicle sirens.

Upon detection, the helmet's integrated LED display provides directional alerts, indicating the direction from which the emergency vehicle is approaching by lighting LEDs positioned on the corresponding side of the helmet. The system's DSP also analyzes the intensity of the siren sound, adjusting the brightness and flashing frequency of the LED alerts accordingly.

The trained machine learning model and/or specialized neural network is used to identify the sound of emergency vehicles and then visually communicate this information through the helmet's LED system. This feature transforms auditory recognition into visual alerts, providing a visual representation of the urgent sounds, which is a significant advancement in enhancing rider safety and situational awareness. This integration of auditory and visual alerts helps ensure that the rider can respond more effectively to emergency situations while maintaining focus on the road.

Described herein are implementations of a blind spot detection method for a helmet using audio signals from directional microphones. The method includes training an engine sound detection machine learning model from motorcycle engine sounds collected under a variety of conditions using an array of microphones configured on a helmet during operation of a vehicle, extracting and recognizing in real-time, using the trained engine sound detection machine learning model, an engine sound from other sounds collected by the array of microphones when the helmet is used during operation of the vehicle, separating direct engine sounds from potential reflected signals to estimate distance and direction to potential objects associated with the potential reflected signals, and providing alerts via the helmet upon detection of an object in a blind spot of the vehicle based on the estimated distance and direction to the potential objects.

Described herein are implementations of a blind spot detection system for a helmet using audio signals from directional microphones. In implementations, the helmet includes an array of microphones deployed around a perimeter of the helmet, and a processor in communication with the array of microphones. The processor configured to extract and recognize in real-time, using a trained engine sound detection machine learning model, an engine sound from other sounds collected by the array of microphones when the helmet is used during operation of a vehicle, separate direct engine sounds from potential reflected signals to estimate distance and direction to potential objects associated with the potential reflected signals, and provide alerts via the helmet upon detection of an object in a blind spot of the vehicle based on the estimated distance and direction to the potential objects.

Described herein is a method. The method includes training an engine sound detection machine learning model from motorcycle engine sounds collected under a variety of conditions using microphones configured on a helmet during operation of a vehicle, recognizing in real-time, using the trained engine sound detection machine learning model, one or more engine sounds from sounds collected by the microphones when the helmet is used during operation of the vehicle, separating direct engine sounds from potential reflected signals within the recognized one or more engine sounds to estimate distance and direction to potential objects associated with the potential reflected signals, and providing alerts via the helmet upon detection of one or more of objects of the potential objects in a blind spot of the vehicle based on the estimated distance and direction to the one or more potential objects in the blind spot.

In further aspects, the microphones are an array of microphones deployed around a perimeter of the helmet. In further aspects, the method further includes extracting in real-time, using a feature extraction component, Mel Frequency Cepstral Coefficients from the sounds, wherein the Mel Frequency Cepstral Coefficients are associated with the one or more engine sounds. In further aspects, the trained engine sound detection machine learning model recognizes the one or more engine sounds based on the Mel Frequency Cepstral Coefficients. In further aspects, the method further includes filtering out in real-time, using the trained engine sound detection machine learning model, other sounds from the sounds collected by the microphones when the helmet is used during operation of the vehicle. In further aspects, the method further includes applying frequency domain techniques to the direct engine sounds and the potential reflected signals to estimate time delays for estimating the distance and the direction. In further aspects, the variety of conditions includes different engine operating states and different environmental conditions.

Described herein is a helmet. The helmet includes an array of microphones deployed around a perimeter of the helmet, and a processor in communication with the array of microphones. The processor is configured to recognize in real-time, using a trained engine sound detection machine learning model, an engine sound from sounds collected by the array of microphones when the helmet is used during operation of a vehicle, separate a direct engine sound from potential reflected signals within the recognized engine sound to estimate distance and direction to potential objects associated with the potential reflected signals, and provide alerts via the helmet upon detection of an object of the potential objects in a blind spot of the vehicle based on the estimated distance and direction to the potential objects.

In further aspects, the processor is further configured to extract a feature set from the sounds for use with the trained engine sound detection machine learning model to recognize the engine sound. In further aspects, the feature set includes Mel Frequency Cepstral Coefficients associated with the engine sound. In further aspects, the trained engine sound detection machine learning model recognizes the engine sound based on the Mel Frequency Cepstral Coefficients. In further aspects, the processor is further configured to filter out, in real-time, other sounds from the sounds collected by the array of microphones when the helmet is used during operation of the vehicle. In further aspects, the processor is further configured to apply frequency domain techniques to the direct engine sounds and the potential reflected signals to estimate time delays for estimating the distance and the direction.

Described herein is a method. The method includes recognizing in real-time, using a trained engine sound detection machine learning model, an engine sound from sounds collected by array of microphones deployed on a helmet used during operation of a vehicle, separating, by a processor, a direct engine sound from potential reflected signals within the recognized engine sound to estimate distance and direction to potential objects associated with the potential reflected signals, and providing, by the processor, alerts via the helmet upon detection of an object of the potential objects in a blind spot of the vehicle based on the estimated distance and direction to the potential objects.

In further aspects, the method further includes training the engine sound detection machine learning model from motorcycle engine sounds collected under a variety of conditions using the array of microphones configured on the helmet during operation of the vehicle. In further aspects, the method further includes extracting in real-time, using a feature extraction component, Mel Frequency Cepstral Coefficients from the sounds, wherein the Mel Frequency Cepstral Coefficients are associated with the engine sound. In further aspects, the trained engine sound detection machine learning model recognizes the engine sound based on the Mel Frequency Cepstral Coefficients. In further aspects, the method further includes filtering out in real-time, using the trained engine sound detection machine learning model, other sounds from the sounds collected by the array of microphones when the helmet is used during operation of the vehicle. In further aspects, the method further includes applying frequency domain techniques to the direct engine sound and the potential reflected signals to estimate time delays for estimating the distance and the direction. In further aspects, the variety of conditions includes different engine operating states and different environmental conditions.

Described herein is a method for providing alerts in a helmet. The method includes recognizing in real-time, using a trained engine sound detection machine learning model, one or more engine sounds from sounds collected by microphones deployed on the helmet, where the engine sound detection machine learning model is trained from motorcycle engine sounds collected under a variety of conditions using the microphones, separating direct engine sounds from reflected signals within the recognized one or more engine sounds to estimate distance and direction to objects associated with the reflected signals, and providing alerts via the helmet upon detection of one or more of objects in a blind spot of a vehicle based on the estimated distance and direction to the objects in the blind spot.

In further aspects, the microphones are an array of microphones deployed around a perimeter of the helmet. In further aspects, the method includes extracting in real-time, using a feature extraction component, Mel Frequency Cepstral Coefficients from the sounds, wherein the Mel Frequency Cepstral Coefficients are associated with the one or more engine sounds. In further aspects, the trained engine sound detection machine learning model recognizes the one or more engine sounds based on the Mel Frequency Cepstral Coefficients. In further aspects, the method includes filtering out in real-time, using the trained engine sound detection machine learning model, other sounds from the sounds collected by the microphones. In further aspects, the method includes applying frequency domain techniques to the direct engine sounds and the reflected signals to estimate time delays for estimating the distance and the direction. In further aspects, the variety of conditions includes different engine operating states and different environmental conditions.

Described herein is a helmet which includes an array of microphones deployed around a perimeter of the helmet, and a processor in communication with the array of microphones. The processor configured to recognize in real-time, using a trained engine sound detection machine learning model, an engine sound from sounds collected by the array of microphones, separate a direct engine sound from reflected signals within the recognized engine sound to estimate distance and direction to objects associated with the reflected signals, and provide alerts via the helmet upon detection of an object in a blind spot of a vehicle based on the estimated distance and direction to the objects.

In further aspects, the processor is further configured to extract a feature set from the sounds for use with the trained engine sound detection machine learning model to recognize the engine sound. In further aspects, the feature set includes Mel Frequency Cepstral Coefficients associated with the engine sound. In further aspects, the trained engine sound detection machine learning model recognizes the engine sound based on the Mel Frequency Cepstral Coefficients. In further aspects, the processor is further configured to filter out, in real-time, other sounds from the sounds collected by the array of microphones. In further aspects, the processor is further configured to apply frequency domain techniques to the direct engine sounds and the reflected signals to estimate time delays for estimating the distance and the direction.

Described herein is a method for providing alerts in a helmet. The method includes recognizing in real-time, using a trained engine sound detection machine learning model, an engine sound from sounds collected by an array of microphones deployed on the helmet, separating, by a processor, a direct engine sound from reflected signals within the recognized engine sound to estimate distance and direction to objects associated with the reflected signals, and providing, by the processor, the alerts upon detection of an object in a blind spot of a vehicle based on the estimated distance and direction to the objects.

In further aspects, the engine sound detection machine learning model is trained from motorcycle engine sounds collected under a variety of conditions using the array of microphones configured on the helmet. In further aspects, the method includes extracting in real-time, using a feature extraction component, Mel Frequency Cepstral Coefficients from the sounds, wherein the Mel Frequency Cepstral Coefficients are associated with the engine sound. In further aspects, the trained engine sound detection machine learning model recognizes the engine sound based on the Mel Frequency Cepstral Coefficients. In further aspects, the method includes filtering out in real-time, using the trained engine sound detection machine learning model, other sounds from the sounds collected by the array of microphones. In further aspects, the method includes applying frequency domain techniques to the direct engine sound and the reflected signals to estimate time delays for estimating the distance and the direction. In further aspects, the variety of conditions includes different engine operating states and different environmental conditions.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for providing alerts in a helmet, the method comprising:
recognizing in real-time, using a trained engine sound detection machine learning model, one or more engine sounds from sounds collected by microphones deployed on the helmet, wherein the engine sound detection machine learning model is trained from motorcycle engine sounds collected under a variety of conditions using the microphones;
separating direct engine sounds from reflected signals within the recognized one or more engine sounds to estimate distance and direction to objects associated with the reflected signals; and
providing alerts via the helmet upon detection of one or more of objects in a blind spot of a vehicle based on the estimated distance and direction to the objects in the blind spot.

2. The method of claim 1, wherein the microphones are an array of microphones deployed around a perimeter of the helmet.

3. The method of claim 1, further comprising:
extracting in real-time, using a feature extraction component, Mel Frequency Cepstral Coefficients from the sounds, wherein the Mel Frequency Cepstral Coefficients are associated with the one or more engine sounds.

4. The method of claim 3, wherein the trained engine sound detection machine learning model recognizes the one or more engine sounds based on the Mel Frequency Cepstral Coefficients.

5. The method of claim 3, further comprising:
filtering out in real-time, using the trained engine sound detection machine learning model, other sounds from the sounds collected by the microphones.

6. The method of claim 5, further comprising:
applying frequency domain techniques to the direct engine sounds and the reflected signals to estimate time delays for estimating the distance and the direction.

7. The method of claim 1, wherein the variety of conditions includes different engine operating states and different environmental conditions.

8. A helmet, comprising:
an array of microphones deployed around a perimeter of the helmet; and
a processor in communication with the array of microphones, the processor configured to:
recognize in real-time, using a trained engine sound detection machine learning model, an engine sound from sounds collected by the array of microphones;
separate a direct engine sound from reflected signals within the recognized engine sound to estimate distance and direction to objects associated with the reflected signals; and
provide alerts via the helmet upon detection of an object in a blind spot of a vehicle based on the estimated distance and direction to the objects.

9. The helmet of claim 8, wherein the processor is further configured to:
extract a feature set from the sounds for use with the trained engine sound detection machine learning model to recognize the engine sound.

10. The helmet of claim 9, wherein the feature set includes Mel Frequency Cepstral Coefficients associated with the engine sound.

11. The helmet of claim 10, wherein the trained engine sound detection machine learning model recognizes the engine sound based on the Mel Frequency Cepstral Coefficients.

12. The helmet of claim 8, wherein the processor is further configured to:
filter out, in real-time, other sounds from the sounds collected by the array of microphones.

13. The helmet of claim 12, wherein the processor is further configured to:
apply frequency domain techniques to the direct engine sounds and the reflected signals to estimate time delays for estimating the distance and the direction.

14. A method for providing alerts in a helmet, the method comprising:
recognizing in real-time, using a trained engine sound detection machine learning model, an engine sound from sounds collected by an array of microphones deployed on the helmet;
separating, by a processor, a direct engine sound from reflected signals within the recognized engine sound to estimate distance and direction to objects associated with the reflected signals; and
providing, by the processor, the alerts upon detection of an object in a blind spot of a vehicle based on the estimated distance and direction to the objects.

15. The method of claim 14, wherein the engine sound detection machine learning model is trained from motorcycle engine sounds collected under a variety of conditions using the array of microphones configured on the helmet.

16. The method of claim 14, further comprising:
extracting in real-time, using a feature extraction component, Mel Frequency Cepstral Coefficients from the sounds, wherein the Mel Frequency Cepstral Coefficients are associated with the engine sound.

17. The method of claim 16, wherein the trained engine sound detection machine learning model recognizes the engine sound based on the Mel Frequency Cepstral Coefficients.

18. The method of claim 14, further comprising:
filtering out in real-time, using the trained engine sound detection machine learning model, other sounds from the sounds collected by the array of microphones.

19. The method of claim 18, further comprising:
applying frequency domain techniques to the direct engine sound and the reflected signals to estimate time delays for estimating the distance and the direction.

20. The method of claim 15, wherein the variety of conditions includes different engine operating states and different environmental conditions.
